(19) United States
(12) Patent Application Publication
(10) Pub. No.: US 2025/0342522 A1
(43) Pub. Date: Nov. 6, 2025

(54) Technologies for Detecting Cash-Related Money Laundering

(71) Applicant: The PNC Financial Services Group, Inc., Pittsburgh, PA (US)

(72) Inventors: Dongmei Wang, Charlotte, NC (US); Lucas Lafferty, Staten Island, NY (US); Jacob Harold Schoifet, New York, NY (US); Chandra V. Keerthi, Pittsburgh, PA (US); Amanda McCracken, Westerville, OH (US)

(21) Appl. No.: 19/195,851

(22) Filed: May 1, 2025

Related U.S. Application Data
(60) Provisional application No. 63/640,961, filed on May 1, 2024.

(51) Int. Cl. G06Q 40/02

(52) U.S. Cl. CPC G06Q 40/02

(57) ABSTRACT

Technologies for detecting cash-related money laundering include a compute device. The compute device may include circuitry configured to obtain historical financial transaction data indicative of financial transactions made by account holders associated with a financial institution. The circuitry may also be configured to create, based on the historical financial transaction data, one or more features for use by a money laundering scenario detection model, provide the one or more features to the money laundering scenario detection model to detect the presence of one or more cash-based money laundering scenarios, including at least one of commingling of funds or conversion of bills from one denomination to a larger denomination, and provide, in response to a determination that a cash-based money laundering scenario has been detected, an alert indicative of the detected cash-based money laundering scenario.

### RELATED APPLICATIONS

This application claims the benefit of U.S. Provisional Application No. 63/640,961 filed May 1, 2024 for “Technologies for Detecting Cash-Related Money Laundering,” which is hereby incorporated by reference in its entirety.

### BACKGROUND

Financial institutions, such as banks, are subject to a wide array of regulations. Among those regulations are ones directed to detecting and curtailing financial crimes, such as money laundering. There are typically three stages to the money laundering process to release laundered funds into the financial system. The three stages are placement, layering, and integration. Placement is an important stage, as it relates to detecting where illegitimate money is introduced into the financial system. Cash is considered a particularly risky type of asset in the placement stage as it provides less of a digital trace compared to other forms of money. Further, cash is universally accepted without the need for third-party involvement (e.g., a credit card company or the like), and is readily broken down into smaller amounts (e.g., to avoid satisfying certain money laundering detection thresholds). In addition, cash transactions can be made relatively quickly, thereby reducing the window of time available for detection of money laundering.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements. The detailed description particularly refers to the accompanying figures in which:

FIG. 1 is a simplified block diagram of at least one embodiment of a system for detecting cash-related money laundering;

FIG. 2 is a simplified block diagram of at least one embodiment of a compute device of the system of FIG. 1;

FIGS. 3-6 are simplified block diagrams of at least one embodiment of a method for detecting cash-related money laundering scenarios that may be executed by the system of FIG. 1; and

FIG. 7 is a diagram of at least one embodiment of a process of training and utilizing one or models for detecting cash-related money laundering that may be utilized in the system of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

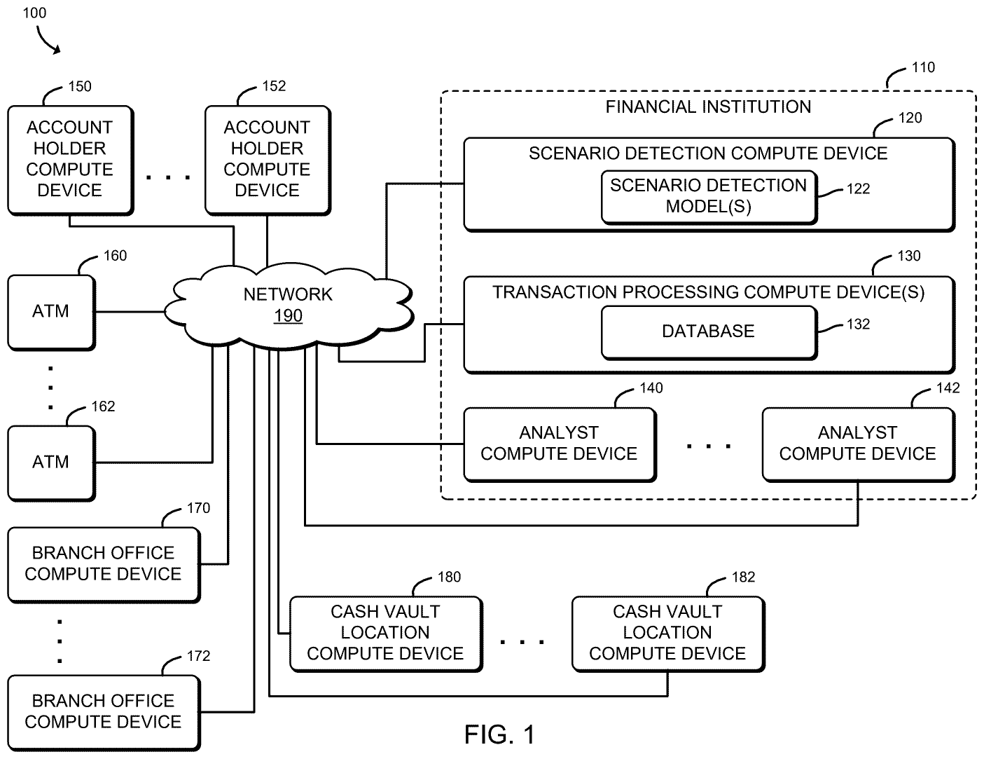

Referring now to FIG. 1, a system 100 for detecting cash-related money laundering scenarios includes, in the illustrative embodiment, a scenario detection compute device 120 associated with a financial institution 110 (e.g., a bank). The scenario detection compute device 120, in the illustrative embodiment, is communicatively connected to a set of one or more transaction processing compute devices 130, which, in operation, process financial transactions (e.g., cash-related transactions such as deposits and withdrawals) initiated by account holders (e.g., customers) of the financial institution 110. As indicated in FIG. 1, the transaction processing compute devices 130 are communicatively connected to account holder compute devices 150, 152, automated teller machines (ATMs) 160, 162, branch office compute devices 170, 172 (e.g., compute devices operated at branch offices of the financial institution 110), and cash vault location compute devices 180, 182 (e.g., compute devices operated at locations where a corresponding cash vault is present (e.g., to facilitate cash transactions for the account holders)). In operation, the transaction processing compute devices 130 may store records of the financial transactions (e.g., taking place in connection with the devices 150, 152, 160, 162, 170, 172, 180, 182) in a database 132 (e.g., a system of record).

The scenario detection compute device 120, in operation, utilizes one or more scenario detection models 122 (e.g., machine learning models) to detect the presence of cash-related money laundering scenarios. As cash-based transactions leave less of a digital record than other forms of transactions (e.g., credit card payments), the scenario detection compute device 120 creates features (e.g., combinations of data, information extrapolated from underlying data, etc.) to operate as proxies for information that cannot be directly collected. The scenario detection compute device 120 provides those features to the scenario detection model(s) 122 to determine whether certain cash-related money laundering scenarios (e.g., scenarios indicative of potential money laundering), such as commingling of funds and/or conversion of small denomination bills to large denomination bills, are present in the data. In doing so, the scenario detection compute device 120 may utilize records of the financial transactions (e.g., produced by the transaction processing compute device(s) 130) and other information, such as information about the account holders (e.g., industry or line of business) and location information (e.g., zip codes, proximity to countries designated as high risk, etc.), as described in more detail herein. In response to a determination that a cash-related money laundering scenario has been detected, the scenario detection compute device 120 may send a corresponding alert to one or more analyst compute devices 140, 142 (e.g., operated by a team of analysts) to review the detection of the scenario and confirm whether money laundering indeed appears to have occurred. As such, and unlike conventional systems, the system 100 enables the financial institution 110 to more readily detect cash-related money laundering situations and maintain compliance with corresponding banking regulations.

While a limited number of compute devices 120, 130, 140, 142, 150, 152, 160, 162, 170, 172, 180, 182 are shown in FIG. 1 for simplicity and clarity, it should be understood that the number of compute devices, in practice, may range in the tens, hundreds, thousands, or more. Likewise, it should be understood that the compute devices 120, 130, 140, 142, 150, 152, 160, 162, 170, 172, 180, 182 may be distributed differently or perform different roles than the configuration shown in FIG. 1. Further, though shown as separate compute devices 120, 130, 140, 142, 150, 152, 160, 162, 170, 172, 180, 182 in some embodiments, the functionality of one or more of the compute devices 120, 130, 140, 142, 150, 152, 160, 162, 170, 172, 180, 182 may be combined into fewer compute devices (the scenario detection compute device 120 may be combined with the transaction processing compute devices 130 and/or the analyst compute devices 140, 142) and/or distributed across more compute devices than those shown in FIG. 1 (e.g., the scenario detection compute device 120 may comprise multiple compute devices).

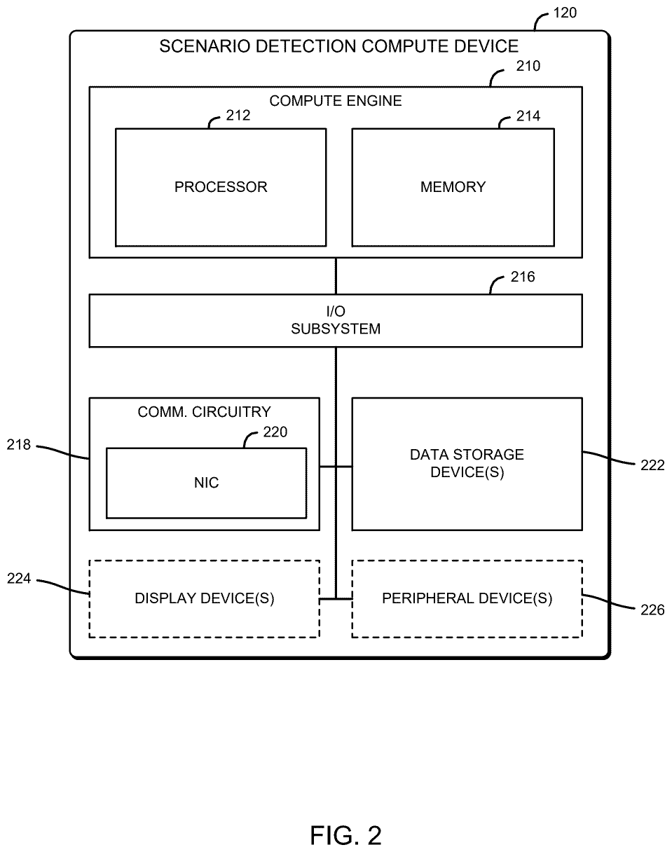

Referring now to FIG. 2, the illustrative scenario detection compute device 120 includes a compute engine 210, an input/output (I/O) subsystem 216, communication circuitry 218, and one or more data storage devices 222. In some embodiments, the scenario detection compute device 120 may include one or more display devices 224 and/or one or more peripheral devices 226 (e.g., a mouse, a physical keyboard, etc.). In some embodiments, one or more of the illustrative components may be incorporated in, or otherwise form a portion of, another component. The compute engine 210 may be embodied as any type of device or collection of devices capable of performing various compute functions described below. In some embodiments, the compute engine 210 may be embodied as a single device such as an integrated circuit, an embedded system, a field-programmable gate array (FPGA), a system-on-a-chip (SOC), or other integrated system or device. Additionally, in the illustrative embodiment, the compute engine 210 includes or is embodied as a processor 212 and a memory 214. The processor 212 may be embodied as any type of processor capable of performing the functions described herein. For example, the processor 212 may be embodied as a single or multi-core processor(s), a microcontroller, or other processor or processing/controlling circuit. In some embodiments, the processor 212 may be embodied as, include, or be coupled to an FPGA, an application specific integrated circuit (ASIC), reconfigurable hardware or hardware circuitry, or other specialized hardware to facilitate performance of the functions described herein.

In embodiments, the processor 212 is capable of receiving, e.g., from the memory 214 or via the I/O subsystem 216, a set of instructions which when executed by the processor 212 cause the scenario detection compute device 120 to perform one or more operations described herein. In embodiments, the processor 212 is further capable of receiving, e.g., from the memory 214 or via the I/O subsystem 216, one or more signals from external sources, e.g., from the peripheral devices 226 or via the communication circuitry 218 from an external compute device, external source, or external network. As one will appreciate, a signal may contain encoded instructions and/or information. In embodiments, once received, such a signal may first be stored, e.g., in the memory 214 or in the data storage device(s) 222, thereby allowing for a time delay in the receipt by the processor 212 before the processor 212 operates on a received signal. Likewise, the processor 212 may generate one or more output signals, which may be transmitted to an external device, e.g., an external memory or an external compute engine via the communication circuitry 218 or, e.g., to one or more display devices 224. In some embodiments, a signal may be subjected to a time shift in order to delay the signal. For example, a signal may be stored on one or more storage devices 222 to allow for a time shift prior to transmitting the signal to an external device. One will appreciate that the form of a particular signal will be determined by the particular encoding a signal is subject to at any point in its transmission (e.g., a signal stored will have a different encoding than a signal in transit, or, e.g., an analog signal will differ in form from a digital version of the signal prior to an analog-to-digital (A/D) conversion).

The main memory 214 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. In some embodiments, all or a portion of the main memory 214 may be integrated into the processor 212. In operation, the main memory 214 may store various software and data used during operation such as one or more scenario detection models, alerts, applications, libraries, and drivers.

The compute engine 210 is communicatively coupled to other components of the scenario detection compute device 120 via the I/O subsystem 216, which may be embodied as circuitry and/or components to facilitate input/output operations with the compute engine 210 (e.g., with the processor 212 and the main memory 214) and other components of the scenario detection compute device 120. For example, the I/O subsystem 216 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 216 may form a portion of a system-on-a-chip (SoC) and be incorporated, along with one or more of the processor 212, the main memory 214, and other components of the scenario detection compute device 120, into the compute engine 210.

The communication circuitry 218 may be embodied as any communication circuit, device, or collection thereof, capable of enabling communications over a network between the scenario detection compute device 120 and another device (e.g., a compute device 130, 140, 142, 150, 152, 160, 162, 170, 172, 180, 182, etc.). The communication circuitry 218 may be configured to use any one or more communication technology (e.g., wired or wireless communications) and associated protocols (e.g., Ethernet, Wi-Fi®, WiMAX, Bluetooth®, etc.) to effect such communication.

The illustrative communication circuitry 218 includes a network interface controller (NIC) 220. The NIC 220 may be embodied as one or more add-in-boards, daughter cards, network interface cards, controller chips, chipsets, or other devices that may be used by the scenario detection compute device 120 to connect with another compute device (e.g., a compute device 130, 140, 142, 150, 152, 160, 162, 170, 172, 180, 182, etc.). In some embodiments, the NIC 220 may be embodied as part of a system-on-a-chip (SoC) that includes one or more processors, or included on a multichip package that also contains one or more processors. In some embodiments, the NIC 220 may include a local processor (not shown) and/or a local memory (not shown) that are both local to the NIC 220. Additionally or alternatively, in such embodiments, the local memory of the NIC 220 may be integrated into one or more components of the scenario detection compute device 120 at the board level, socket level, chip level, and/or other levels.

Each data storage device 222, may be embodied as any type of device configured for short-term or long-term storage of data such as, for example, memory devices and circuits, memory cards, hard disk drives, solid-state drives, or other data storage device. Each data storage device 222 may include a system partition that stores data and firmware code for the data storage device 222 and one or more operating system partitions that store data files and executables for operating systems.

Each display device 224 may be embodied as any device or circuitry (e.g., a liquid crystal display (LCD), a light emitting diode (LED) display, a cathode ray tube (CRT) display, etc.) configured to display visual information (e.g., text, graphics, etc.) to a user. In some embodiments, a display device 224 may be embodied as a touch screen (e.g., a screen incorporating resistive touchscreen sensors, capacitive touchscreen sensors, surface acoustic wave (SAW) touchscreen sensors, infrared touchscreen sensors, optical imaging touchscreen sensors, acoustic touchscreen sensors, and/or other type of touchscreen sensors) to detect selections of on-screen user interface elements or gestures from a user.

In the illustrative embodiment, the components of the scenario detection compute device 120 are housed in a single unit. However, in other embodiments, the components may be in separate housings, in separate racks of a data center, and/or spread across multiple data centers or other facilities. The compute devices 130, 140, 142, 150, 152, 160, 162, 170, 172, 180, 182 may have components similar to those described in FIG. 2 with reference to the scenario detection compute device 120. The description of those components of the scenario detection compute device 120 is equally applicable to the description of components of the compute devices 130, 140, 142, 150, 152, 160, 162, 170, 172, 180, 182. Further, it should be appreciated that any of the devices 130, 140, 142, 150, 152, 160, 162, 170, 172, 180, 182 may include other components, sub-components, and devices commonly found in a computing device, which are not discussed above in reference to the scenario detection compute device 120 and not discussed herein for clarity of the description.

In the illustrative embodiment, the compute devices 120, 130, 140, 142, 150, 152, 160, 162, 170, 172, 180, 182 are in communication via a network 190, which may be embodied as any type of wired or wireless communication network, including global networks (e.g., the internet), wide area networks (WANs), local area networks (LANs), digital subscriber line (DSL) networks, cable networks (e.g., coaxial networks, fiber networks, etc.), cellular networks (e.g., Global System for Mobile Communications (GSM), Long Term Evolution (LTE), Worldwide Interoperability for Microwave Access (WiMAX), 3G, 4G, 5G, etc.), a radio area network (RAN), or any combination thereof.

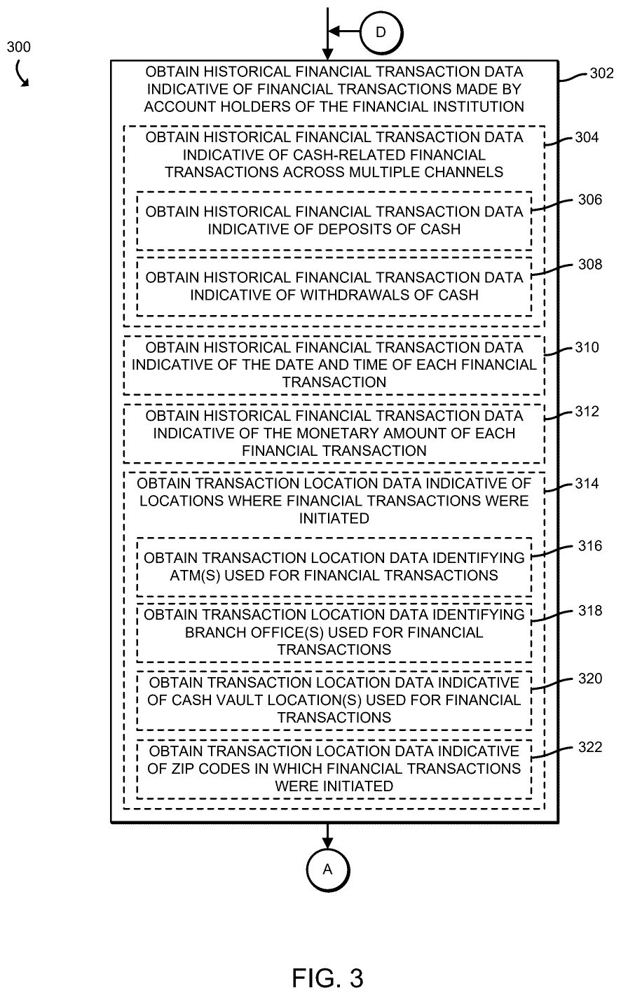

Referring now to FIG. 3, the system 100, and specifically, the scenario detection compute device 120, in the illustrative embodiment, may perform a method 300 for detecting cash-related money laundering. The method 300, in the illustrative embodiment, begins with block 302 in which the scenario detection compute device 120 obtains historical financial transaction data (e.g., through a request to the transaction processing compute device(s) 130 to read the data from the database 132) indicative of financial transactions made by account holders (e.g., customers) of the financial institution 110. In doing so, and as indicated in block 304, the scenario detection compute device 120 in the illustrative embodiment obtains historical financial transaction data indicative of cash-related financial transaction performed across multiple channels (e.g., ATMs 160, 162, branch offices, etc.). As indicated in block 306, the scenario detection compute device 120 obtains historical financial transaction data indicative of deposits of cash (e.g., made by a customer into a corresponding financial account held with the financial institution 110). Similarly, and as indicated in block 308, the scenario detection compute device, in the illustrative embodiment, obtains historical financial transaction data indicative of withdrawals of cash (e.g., from a corresponding financial account held with the financial institution 110).

As indicated in block 310, the scenario detection compute device 120 may obtain data indicative of the date and, in the illustrative embodiment, the time, associated with each financial transaction. Further, and as indicated in block 312, the scenario detection compute device 120 may obtain historical financial transaction data that is also indicative of the monetary amount (e.g., number of dollars) of each financial transaction (e.g., each deposit or withdrawal). The scenario detection compute device 120 may obtain transaction location data (e.g., from the database 132 via a corresponding request to the financial transaction compute device(s) 130) which may be embodied as any data indicative of locations where the financial transactions (e.g., the financial transactions represented in the historical financial transaction data) were initiated, as indicated in block 314. In doing so, and as indicated in block 316, the scenario detection compute device 120 may obtain transaction location data that identifies one or more ATMs 160, 162 (e.g., by a unique identification code that can be associated with a corresponding geographic location, an address, etc.) used for one or more of the financial transactions. The scenario detection compute device 120 may obtain transaction location data identifying one or more branch offices (e.g., as reported by corresponding branch office compute devices 170, 172) used for financial transactions, as indicated in block 318. The scenario detection compute device 120 may also obtain transaction location data indicative of cash vault locations (e.g., as reported by cash vault location compute devices 180, 182) used for financial transaction (e.g., initiated on behalf of a corresponding account holder), as indicated in block 320. In some embodiments, the scenario detection compute device 120 may obtain transaction location data indicative of zip codes in which the financial transactions were initiated, as indicated in block 322. In doing so, the scenario detection compute device 120 may look up the zip code (e.g., based on a corresponding request directed to the database 132) associated with a given device identifier (e.g., an ATM identifier, etc. represented in the transaction location data) or may parse the zip code from a street address associated with a given device involved in a financial transaction represented in the historical financial transaction data.

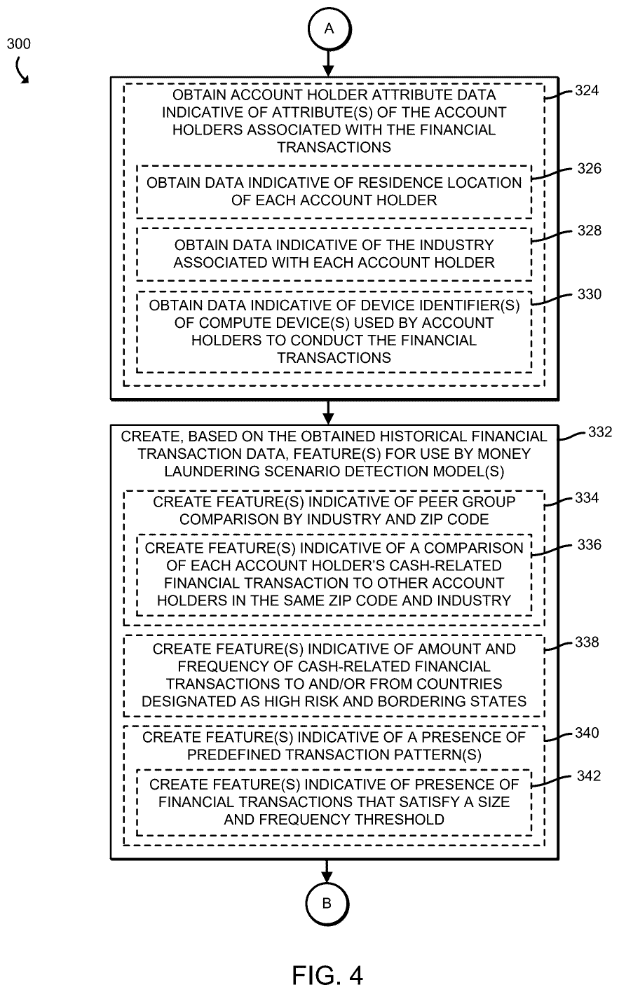

Referring now to FIG. 4, in the illustrative embodiment, continuing the method 300, the scenario detection compute device 120 may obtain (e.g., by requesting the data from the transaction processing compute devices 130) account holder attribute data which may be embodied as any data indicative of one or more attributes of the account holders associated with the financial transactions (e.g., represented in the historical financial transaction data), as indicated in block 324. In doing so, and as indicated in block 326, the scenario detection compute device 120 may obtain data indicative of the residence location (e.g., street address including zip code) of each account holder. The scenario detection compute device 120 may also obtain data indicative of the industry or line of business associated with each account holder, as indicated in block 328. Such information may be collected from each account holder and stored in a corresponding database (e.g., the database 132) during an onboarding process in which each account holder became a customer of the financial institution 110. As indicated in block 330, the scenario detection compute device 120 may obtain data indicative of device identifiers (e.g., internet protocol addresses, cookies or tokens containing identifiers assigned by compute devices of the financial institution 110 for communication sessions, etc.) of compute devices 150, 152 used by account holders to conduct financial transactions.

Subsequently, the scenario detection compute device 120 may create, based at least in part on the obtained historical financial transaction data, one or more features for use by one or more scenario detection models 122, as indicated in block 332. In doing so, and as indicated in block 334, the scenario detection compute device 120 may create one or more features indicative of a peer group comparison by industry and zip code. That is, in some embodiments, the scenario detection compute device 120 may create one or more features indicative of a comparison of each account holder's cash-related financial transactions (e.g., frequency of transactions, monetary amounts of transactions, etc.) to other account holders in the same zip code and industry, as indicated in block 336. The resulting feature may indicate the degree to which a given account holder's cash-related transactions differ from the rest of the population in the same industry and zip code. For example, the feature may indicate the percentage of the population with similar metrics (e.g., frequency, monetary amounts, etc.). The scenario detection compute device 120 may also create one or more features indicative of the amount and frequency of cash-related financial transactions to or from countries designated (e.g., in a predefined data set, e.g., in the data storage 222) as high risk (e.g., for financial crime) and/or states that share a border with any of those countries, as indicated in block 338. The scenario detection compute device 120 may create one or more features indicative of the presence of one or more predefined transaction patterns, as indicated in block 340. In doing so, the scenario detection compute device 120 may create one or more features indicative of the presence of financial transactions that satisfy a size and frequency threshold (e.g., that fall below a defined maximum monetary size and that are greater than a defined minimum frequency, indicative of relatively frequent, small cash transactions), as indicated in block 342. In some embodiments, thresholds may be defined separately based on the type of transaction, such that relatively frequent small deposits would satisfy one set of thresholds and less frequent, large withdrawal would satisfy another set of thresholds (e.g., potentially indicative of a conversion of cash from one denomination to a larger denomination, resulting in fewer bills to transport across a border).

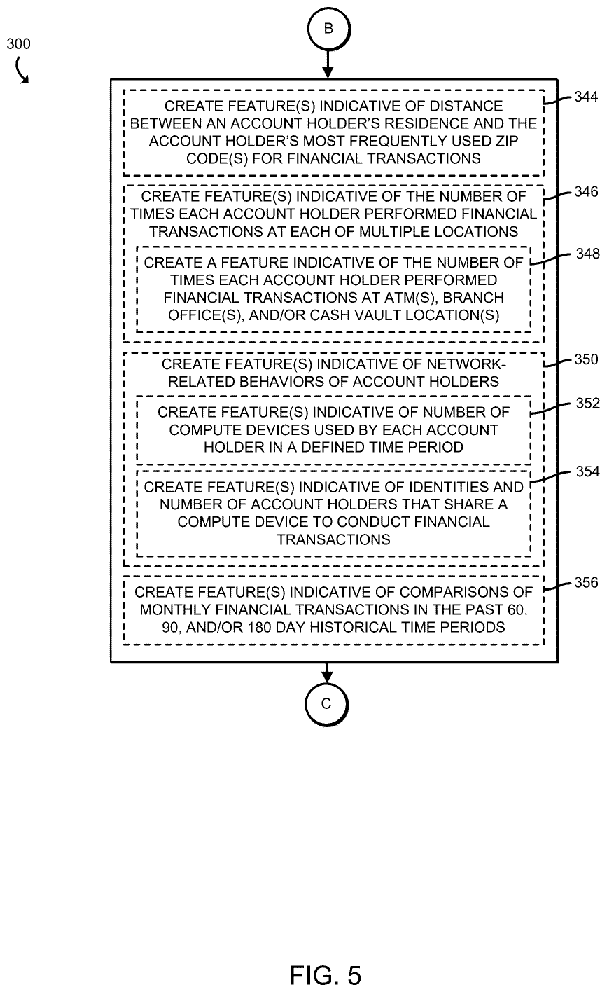

Referring now to FIG. 5, the scenario detection compute device 120 may create one or more features indicative of the distance between the residence of an account holder and the zip code(s) most often used by the account holder for financial transactions (e.g., potentially indicating an abnormal amount of effort to conduct transactions in a particular location when other locations are closer and more convenient for the account holder), as indicated in block 344. The scenario detection compute device 120 may create one or more features indicative of the number of times each account holder performed financial transactions at each of multiple locations, as indicated in block 346. In doing so, the scenario detection compute device 120 may create one or more features indicative of the number of times each account holder performed financial transactions at one or more ATMs 160, 162, branch offices (e.g., associated with the branch office compute devices 170, 172), and/or cash vault locations (e.g., associated with the cash vault locations compute devices 180, 182), as indicated in block 348.

The scenario detection compute device 120 may also create one or more features indicative of network-related behaviors of the account holders, as indicated in block 350. In doing so, the scenario detection compute device 120 may create one or more features indicative of the number of compute devices (e.g., the account holder compute devices 150, 152) used by each account holder in a defined time period (e.g., an hour, a day, etc.), as indicated in block 352. Further, the scenario detection compute device 120 may create one or more features indicative of the identities and the number of account holders that share a compute device (e.g., as indicated by logins of different users with the same account holder compute device 150, 152) to conduct financial transactions, as indicated in block 354. A relatively high level of sharing may be indicative of suspicious activity, such as potential money laundering. The scenario detection compute device 120 may create one or more features indicative of comparisons of monthly financial transactions (e.g., for a given account holder) in the past 60, 90, or 180 day historical time periods (e.g., to identify a trend, such as an increase over time or a decrease over time in the frequency and/or monetary size of the transactions, an increase or decrease in the number of transactions in a particular zip code or through a particular channel (e.g., ATM, branch office, etc.)), as indicated in block 356.

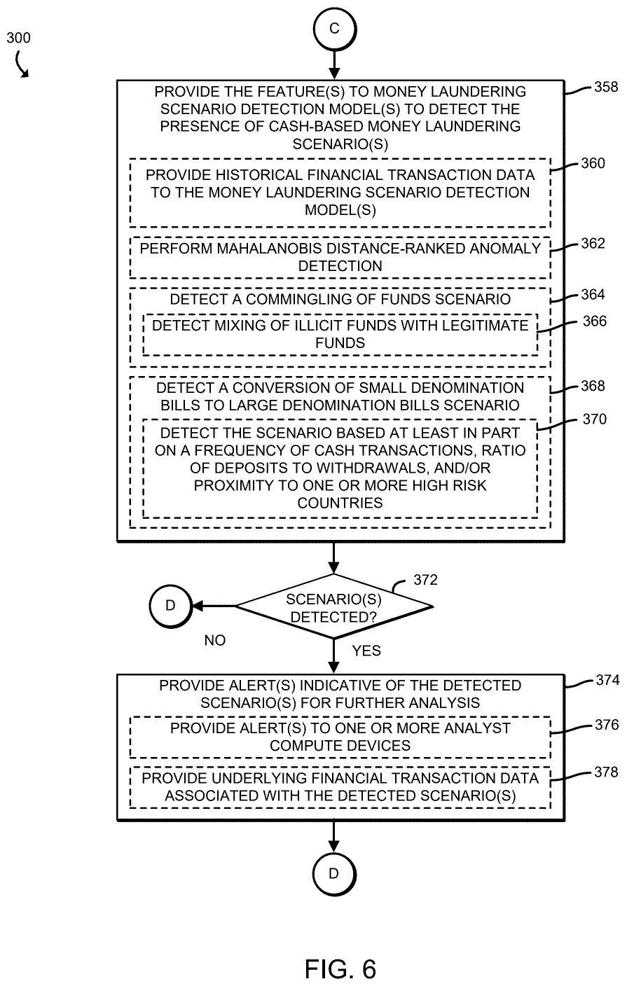

Referring now to FIG. 6, the method 300 in the illustrative embodiment, continues in block 358, in which the scenario detection compute device 120 provides the one or more features (e.g., from block 332) to the one or more scenario detection models 122 to detect the presence of cash-based money laundering scenarios. In doing so, and as indicated, in block 360, the scenario detection compute device 120 may provide at least a subset of the historical financial transaction data to the scenario detection models 122 as well (e.g., in addition to the features from block 332). The scenario detection compute device 120 may perform, using the scenario detection models 122, Mahalanobis distance-ranked anomaly detection. That is, the scenario detection compute device 120 may create a distribution of data points (e.g., each representing an account holder) in a space in which the created features (from block 332) and/or data obtained by the scenario detection compute device 120 (e.g., from block 302) represent dimensions. Further, the scenario detection compute device 120 may determine a center (e.g., centroid) of the distribution and the distance of each data point (e.g., account holder) from the centroid. The greater the distance, the more anomalous the corresponding account holder is. The scenario detection compute device 120 may perform a dimensionality reduction operation (e.g., principle component analysis) to reduce the dimensionality of the space prior to establishing the distribution and determining the centroid and distance of each account holder from the centroid.

As indicated in block 364, the scenario detection compute device 120 may detect a commingling of funds scenario. That is, the scenario detection compute device 120 may detect a mixing of illicit funds with legitimate funds, as indicated in block 366. Additionally or alternatively, the scenario detection compute device 120 may detect a conversion of relatively small denomination bills to large denomination bills scenario, as indicated in block 368. In doing so, and as indicated in block 370, the scenario detection compute device 120 may detect the scenario based at least in part on a frequency of cash transactions, ratio of deposits to withdrawals (e.g., with a relatively high rate of deposits and a relatively slow rate of withdrawals being indicative of the conversion of small denomination bills to large denomination bills), and/or proximity of the transactions to one or more high risk countries (e.g., in a border state, in which a closer proximity is more indicative of preparation to transport the cash across the border).

In block 372, the scenario detection compute device 120 determines the subsequent course of action based on whether a scenario was detected in block 358. If not, the method 300 loops back to block 302 of FIG. 3 to obtain additional historical financial transaction data. Otherwise, if a scenario has been detected, the method 300 advances to block 374 in which the scenario detection compute device 120, in the illustrative embodiment, provides one or more alerts indicative of the detected scenario or scenarios for further analysis (e.g., for human analysis). In doing so, and as indicated in block 376, the scenario detection compute device 120, in the illustrative embodiment, provides one or more alerts to one or more of the analyst compute devices 140, 142 (e.g., in an email, in a notification in a dashboard, etc.). Further, the scenario detection compute device 120, in the illustrative embodiment, provides the underlying financial transaction data associated with the one or more detected scenarios (e.g., for review and confirmation by an analyst that the data indeed indicates potential cash-related money laundering). Subsequently, the method loops back to block 302 in which the scenario detection compute device 120 obtains additional historical financial transaction data for analysis. Though the operations of the method 300 are described in a particular sequence, it should be understood that in other embodiments, operations may be performed in a different order and/or in parallel.

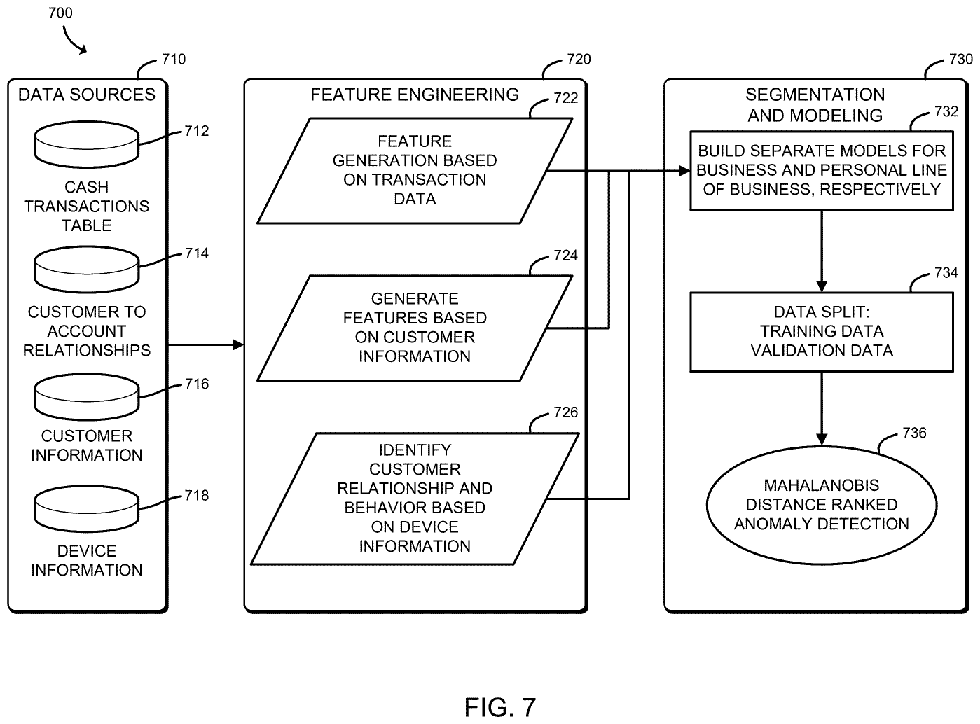

Referring briefly to the diagram 700 of FIG. 7, in at least some embodiments, the system 100 may use data sources 710 that include a cash transactions table 712, a customer to account relationships data set 714 (e.g., data indicative of associations between financial accounts and customers), a customer information data set 716 (e.g., data indicative of the industry or line of business of each customer, residence address of the customer, etc.), and device information 718 (e.g., data indicative of identifiers and locations of compute devices 150, 152, 160, 162, 170, 172, 180, 182 that may be used in connection with financial transactions performed by the customers). The data sources 702 correspond to the database 132 of FIG. 1 (e.g., the database 132 may include multiple databases or data sources). As additionally indicated, the system 100 utilizes feature engineering 720, which corresponds to block 332 of the method 300 described above. The feature engineering 720 includes feature generation based on transaction data (e.g., transaction summary based on customer line of business or industry, zip code, proximity to a high risk jurisdiction, time windows for historical behaviors), as indicated in block 722, generation of features based on customer information (e.g., customer address, line of business or industry, zip code), as indicated in block 724, and identification of customer relationships and behaviors based on device information (e.g., type of device logged into an account, customers who share the same device, number of devices per customer), as indicated in block 726.

Further, the system 100 utilizes segmentation and modeling operations 730. Those operations may include building of separate models for business and personal lines of business, respectively, as indicated in block 732. Additionally, the operations, in the illustrative embodiment, include splitting the obtained data for training operations and validation operations (e.g., training and validating the scenario detection model(s) 122), as indicated in block 734. Further, the operations, in the illustrative embodiment, include performing Mahalanobis distance ranked anomaly detection, as indicated in block 736 and as described in detail with reference to block 362 of FIG. 6.

While certain illustrative embodiments have been described in detail in the drawings and the foregoing description, such an illustration and description is to be considered as exemplary and not restrictive in character, it being understood that only illustrative embodiments have been shown and described and that all changes and modifications that come within the spirit of the disclosure are desired to be protected. There exist a plurality of advantages of the present disclosure arising from the various features of the apparatus, systems, and methods described herein. It will be noted that alternative embodiments of the apparatus, systems, and methods of the present disclosure may not include all of the features described, yet still benefit from at least some of the advantages of such features. Those of ordinary skill in the art may readily devise their own implementations of the apparatus, systems, and methods that incorporate one or more of the features of the present disclosure.

### EXAMPLES

Illustrative examples of the technologies disclosed herein are provided below. An embodiment of the technologies may include any one or more, and any combination of, the examples described below.

Example 1 includes a compute device comprising circuitry configured to obtain historical financial transaction data indicative of financial transactions made by account holders associated with a financial institution; create, based on the historical financial transaction data, one or more features for use by a money laundering scenario detection model; provide the one or more features to the money laundering scenario detection model to detect the presence of one or more cash-based money laundering scenarios, including at least one of commingling of funds or conversion of bills from one denomination to a larger denomination; and provide, in response to a determination that a cash-based money laundering scenario has been detected, an alert indicative of the detected cash-based money laundering scenario.

Example 2 includes the subject matter of Example 1, and wherein to obtain historical financial transaction data comprises to obtain historical financial transaction data indicative of cash-related financial transactions across multiple channels.

Example 3 includes the subject matter of any of Examples 1 and 2, and wherein to obtain historical financial transaction data indicative of cash-related financial transactions comprises to obtain historical financial transaction data indicative of deposits of cash.

Example 4 includes the subject matter of any of Examples 1-3, and wherein to obtain historical financial transaction data indicative of cash-related financial transactions comprises to obtain historical financial transaction data indicative of withdrawals of cash.

Example 5 includes the subject matter of any of Examples 1-4, and wherein to obtain historical financial transaction data comprises to obtain historical financial transaction data indicative of a date and time of each financial transaction.

Example 6 includes the subject matter of any of Examples 1-5, and wherein to obtain historical financial transaction data comprises to obtain historical financial transaction data indicative of a monetary amount of each financial transaction.

Example 7 includes the subject matter of any of Examples 1-6, and wherein to obtain historical financial transaction data comprises to obtain transaction location data indicative of locations where the financial transactions were initiated.

Example 8 includes the subject matter of any of Examples 1-7, and wherein to obtain transaction location data comprises to obtain transaction location data indicative of one or more automated teller machines used for the financial transactions.

Example 9 includes the subject matter of any of Examples 1-8, and wherein to obtain transaction location data comprises to obtain transaction location data indicative of one or more branch offices of the financial institution used for the financial transactions.

Example 10 includes the subject matter of any of Examples 1-9, and wherein to obtain transaction location data comprises to obtain transaction location data indicative of one or more cash vault locations used for the financial transactions.

Example 11 includes the subject matter of any of Examples 1-10, and wherein to obtain transaction location data comprises to obtain transaction location data indicative of one or more zip codes used for the financial transactions.

Example 12 includes the subject matter of any of Examples 1-11, and wherein to obtain historical financial transaction data comprises to obtain account holder attribute data indicative of one or more attributes of the account holders associated with the financial transactions.

Example 13 includes the subject matter of any of Examples 1-12, and wherein to obtain account holder attribute data comprises to obtain data indicative of a residence location of each account holder.

Example 14 includes the subject matter of any of Examples 1-13, and wherein to obtain account holder attribute data comprises to obtain data indicative of an industry associated with each account holder.

Example 15 includes the subject matter of any of Examples 1-14, and wherein to obtain account holder attribute data comprises to obtain data indicative of one or more device identifiers of one or more compute devices used by the account holders to conduct the financial transactions.

Example 16 includes the subject matter of any of Examples 1-15, and wherein to create one or more features comprises to create one or more features indicative of a peer group comparison by industry and zip code.

Example 17 includes the subject matter of any of Examples 1-16, and wherein to create one or more features indicative of a peer group comparison comprises to create one or more features indicative of a comparison of cash-related financial transactions of each account holder to other account holders in the same zip code and industry.

Example 18 includes the subject matter of any of Examples 1-17, and wherein to create one or more features comprises to create one or more features indicative of an amount and frequency of cash-related financial transactions to or from countries designated as high risk or one or more states that border one or more of the countries.

Example 19 includes the subject matter of any of Examples 1-18, and wherein to create one or more features comprises to create one or more features indicative of a presence of a predefined transaction pattern.

Example 20 includes the subject matter of any of Examples 1-19, and wherein to create one or more features indicative of a presence of a predefined transaction pattern comprises to create one or more features indicative of a presence of financial transactions that satisfy a size and frequency threshold.

Example 21 includes the subject matter of any of Examples 1-20, and wherein to create one or more features comprises to create one or more features indicative of a distance between a residence of an account holder and a zip code used most frequently by the account holder for financial transactions.

Example 22 includes the subject matter of any of Examples 1-21, and wherein to create one or more features comprises to create one or more features indicative of a number of times each account holder performed financial transactions at each of multiple locations.

Example 23 includes the subject matter of any of Examples 1-22, and wherein to create one or more features indicative of a number of times each account holder performed financial transactions at each of multiple locations comprises to create a feature indicative of the number of times each account holder performed financial transactions at one or more automated teller machines, branch offices, or cash vault locations.

Example 24 includes the subject matter of any of Examples 1-23, and wherein to create one or more features comprises to create one or more features indicative of network-related behaviors of the account holders.

Example 25 includes the subject matter of any of Examples 1-24, and wherein to create one or more features indicative of network-related behaviors of the account holders comprises to create one or more features indicative of a number of compute devices used by each account holder in a defined time period.

Example 26 includes the subject matter of any of Examples 1-25, and wherein to create one or more features indicative of network-related behaviors of the account holders comprises to create one or more features indicative of identities and number of account holders that share a compute device to conduct financial transactions.

Example 27 includes the subject matter of any of Examples 1-26, and wherein to create one or more features comprises to create one or more features indicative of comparisons of monthly financial transactions over 60, 90, or 180 day historical time periods.

Example 28 includes the subject matter of any of Examples 1-27, and wherein the circuitry is further configured to provide the historical financial transaction data to the money laundering scenario detection model.

Example 29 includes the subject matter of any of Examples 1-28, and wherein the circuitry is further configured to perform anomaly detection based on ranking Mahalanobis distances determined from the one or more features.

Example 30 includes the subject matter of any of Examples 1-29, and wherein to detect a commingling of funds scenario comprises to detect mixing of illicit funds with legitimate funds.

Example 31 includes the subject matter of any of Examples 1-30, and wherein to detect a conversion of bills from one denomination to a larger denomination comprises to detect the conversion based at least in part on a frequency of cash transactions, a ratio of deposits to withdrawals, or a proximity to one or more high risk countries.

Example 32 includes the subject matter of any of Examples 1-31, and wherein to provide an alert comprises to provide the alert to an analyst compute device.

Example 33 includes the subject matter of any of Examples 1-32, and wherein to provide an alert comprises to additionally provide the historical financial transaction data associated with the detected scenario.

Example 34 includes a method comprising obtaining, by a compute device, historical financial transaction data indicative of financial transactions made by account holders associated with a financial institution; creating, by the compute device and based on the historical financial transaction data, one or more features for use by a money laundering scenario detection model; providing, by the compute device, the one or more features to the money laundering scenario detection model to detect the presence of one or more cash-based money laundering scenarios, including at least one of commingling of funds or conversion of bills from one denomination to a larger denomination; and providing, by the compute device and in response to a determination that a cash-based money laundering scenario has been detected, an alert indicative of the detected cash-based money laundering scenario.

Example 35 includes the subject matter of Example 34, and wherein obtaining historical financial transaction data comprises obtaining historical financial transaction data indicative of cash-related financial transactions across multiple channels.

Example 36 includes the subject matter of any of Examples 34 and 35, and wherein obtaining historical financial transaction data indicative of cash-related financial transactions comprises obtaining historical financial transaction data indicative of deposits of cash.

Example 37 includes the subject matter of any of Examples 34-36, and wherein obtaining historical financial transaction data indicative of cash-related financial transactions comprises obtaining historical financial transaction data indicative of withdrawals of cash.

Example 38 includes the subject matter of any of Examples 34-37, and wherein obtaining historical financial transaction data comprises obtaining historical financial transaction data indicative of a date and time of each financial transaction.

Example 39 includes the subject matter of any of Examples 34-38, and wherein obtaining historical financial transaction data comprises obtaining historical financial transaction data indicative of a monetary amount of each financial transaction.

Example 40 includes the subject matter of any of Examples 34-39, and wherein obtaining historical financial transaction data comprises obtaining transaction location data indicative of locations where the financial transactions were initiated.

Example 41 includes the subject matter of any of Examples 34-40, and wherein obtaining transaction location data comprises obtaining transaction location data indicative of one or more automated teller machines used for the financial transactions.

Example 42 includes the subject matter of any of Examples 34-41, and wherein obtaining transaction location data comprises obtaining transaction location data indicative of one or more branch offices of the financial institution used for the financial transactions.

Example 43 includes the subject matter of any of Examples 34-42, and wherein obtaining transaction location data comprises obtaining transaction location data indicative of one or more cash vault locations used for the financial transactions.

Example 44 includes the subject matter of any of Examples 34-43, and wherein obtaining transaction location data comprises obtaining transaction location data indicative of one or more zip codes used for the financial transactions.

Example 45 includes the subject matter of any of Examples 34-44, and wherein obtaining historical financial transaction data comprises obtaining account holder attribute data indicative of one or more attributes of the account holders associated with the financial transactions.

Example 46 includes the subject matter of any of Examples 34-45, and wherein obtaining account holder attribute data comprises obtaining data indicative of a residence location of each account holder.

Example 47 includes the subject matter of any of Examples 34-46, and wherein obtaining account holder attribute data comprises obtaining data indicative of an industry associated with each account holder.

Example 48 includes the subject matter of any of Examples 34-47, and wherein obtaining account holder attribute data comprises obtaining data indicative of one or more device identifiers of one or more compute devices used by the account holders to conduct the financial transactions.

Example 49 includes the subject matter of any of Examples 34-48, and wherein creating one or more features comprises creating one or more features indicative of a peer group comparison by industry and zip code.

Example 50 includes the subject matter of any of Examples 34-49, and wherein creating one or more features indicative of a peer group comparison comprises creating one or more features indicative of a comparison of cash-related financial transactions of each account holder to other account holders in the same zip code and industry.

Example 51 includes the subject matter of any of Examples 34-50, and wherein creating one or more features comprises creating one or more features indicative of an amount and frequency of cash-related financial transactions to or from countries designated as high risk or one or more states that border one or more of the countries.

Example 52 includes the subject matter of any of Examples 34-51, and wherein creating one or more features comprises creating one or more features indicative of a presence of a predefined transaction pattern.

Example 53 includes the subject matter of any of Examples 34-52, and wherein creating one or more features indicative of a presence of a predefined transaction pattern comprises creating one or more features indicative of a presence of financial transactions that satisfy a size and frequency threshold.

Example 54 includes the subject matter of any of Examples 34-53, and wherein creating one or more features comprises creating one or more features indicative of a distance between a residence of an account holder and a zip code used most frequently by the account holder for financial transactions.

Example 55 includes the subject matter of any of Examples 34-54, and wherein creating one or more features comprises creating one or more features indicative of a number of times each account holder performed financial transactions at each of multiple locations.

Example 56 includes the subject matter of any of Examples 34-55, and wherein creating one or more features indicative of a number of times each account holder performed financial transactions at each of multiple locations comprises creating a feature indicative of the number of times each account holder performed financial transactions at one or more automated teller machines, branch offices, or cash vault locations.

Example 57 includes the subject matter of any of Examples 34-56, and wherein creating one or more features comprises creating one or more features indicative of network-related behaviors of the account holders.

Example 58 includes the subject matter of any of Examples 34-57, and wherein creating one or more features indicative of network-related behaviors of the account holders comprises creating one or more features indicative of a number of compute devices used by each account holder in a defined time period.

Example 59 includes the subject matter of any of Examples 34-58, and wherein creating one or more features indicative of network-related behaviors of the account holders comprises creating one or more features indicative of identities and number of account holders that share a compute device to conduct financial transactions.

Example 60 includes the subject matter of any of Examples 34-59, and wherein creating one or more features comprises creating one or more features indicative of comparisons of monthly financial transactions over 60, 90, or 180 day historical time periods.

Example 61 includes the subject matter of any of Examples 34-60, and further including providing, by the compute device, the historical financial transaction data to the money laundering scenario detection model.

Example 62 includes the subject matter of any of Examples 34-61, and further including performing, by the compute device, anomaly detection based on ranking Mahalanobis distances determined from the one or more features.

Example 63 includes the subject matter of any of Examples 34-62, and wherein detecting a commingling of funds scenario comprises detecting mixing of illicit funds with legitimate funds.

Example 64 includes the subject matter of any of Examples 34-63, and wherein detecting a conversion of bills from one denomination to a larger denomination comprises detecting the conversion based at least in part on a frequency of cash transactions, a ratio of deposits to withdrawals, or a proximity to one or more high risk countries.

Example 65 includes the subject matter of any of Examples 34-64, and wherein providing an alert comprises providing the alert to an analyst compute device.

Example 66 includes the subject matter of any of Examples 34-65, and wherein providing an alert comprises additionally providing the historical financial transaction data associated with the detected scenario.

Example 67 includes one or more machine-readable storage media comprising a plurality of instructions stored thereon that, in response to being executed, cause a compute device to obtain historical financial transaction data indicative of financial transactions made by account holders associated with a financial institution; create, based on the historical financial transaction data, one or more features for use by a money laundering scenario detection model; provide the one or more features to the money laundering scenario detection model to detect the presence of one or more cash-based money laundering scenarios, including at least one of commingling of funds or conversion of bills from one denomination to a larger denomination; and provide, in response to a determination that a cash-based money laundering scenario has been detected, an alert indicative of the detected cash-based money laundering scenario.

Example 68 includes the subject matter of Example 67, and wherein to obtain historical financial transaction data comprises to obtain historical financial transaction data indicative of cash-related financial transactions across multiple channels.

Example 69 includes the subject matter of any of Examples 67 and 68, and wherein to obtain historical financial transaction data indicative of cash-related financial transactions comprises to obtain historical financial transaction data indicative of deposits of cash.

Example 70 includes the subject matter of any of Examples 67-69, and wherein to obtain historical financial transaction data indicative of cash-related financial transactions comprises to obtain historical financial transaction data indicative of withdrawals of cash.

Example 71 includes the subject matter of any of Examples 67-70, and wherein to obtain historical financial transaction data comprises to obtain historical financial transaction data indicative of a date and time of each financial transaction.

Example 72 includes the subject matter of any of Examples 67-71, and wherein to obtain historical financial transaction data comprises to obtain historical financial transaction data indicative of a monetary amount of each financial transaction.

Example 73 includes the subject matter of any of Examples 67-72, and wherein to obtain historical financial transaction data comprises to obtain transaction location data indicative of locations where the financial transactions were initiated.

Example 74 includes the subject matter of any of Examples 67-73, and wherein to obtain transaction location data comprises to obtain transaction location data indicative of one or more automated teller machines used for the financial transactions.

Example 75 includes the subject matter of any of Examples 67-74, and wherein to obtain transaction location data comprises to obtain transaction location data indicative of one or more branch offices of the financial institution used for the financial transactions.

Example 76 includes the subject matter of any of Examples 67-75, and wherein to obtain transaction location data comprises to obtain transaction location data indicative of one or more cash vault locations used for the financial transactions.

Example 77 includes the subject matter of any of Examples 67-76, and wherein to obtain transaction location data comprises to obtain transaction location data indicative of one or more zip codes used for the financial transactions.

Example 78 includes the subject matter of any of Examples 67-77, and wherein to obtain historical financial transaction data comprises to obtain account holder attribute data indicative of one or more attributes of the account holders associated with the financial transactions.

Example 79 includes the subject matter of any of Examples 67-78, and wherein to obtain account holder attribute data comprises to obtain data indicative of a residence location of each account holder.

Example 80 includes the subject matter of any of Examples 67-79, and wherein to obtain account holder attribute data comprises to obtain data indicative of an industry associated with each account holder.

Example 81 includes the subject matter of any of Examples 67-80, and wherein to obtain account holder attribute data comprises to obtain data indicative of one or more device identifiers of one or more compute devices used by the account holders to conduct the financial transactions.

Example 82 includes the subject matter of any of Examples 67-81, and wherein to create one or more features comprises to create one or more features indicative of a peer group comparison by industry and zip code.

Example 83 includes the subject matter of any of Examples 67-82, and wherein to create one or more features indicative of a peer group comparison comprises to create one or more features indicative of a comparison of cash-related financial transactions of each account holder to other account holders in the same zip code and industry.

Example 84 includes the subject matter of any of Examples 67-83, and wherein to create one or more features comprises to create one or more features indicative of an amount and frequency of cash-related financial transactions to or from countries designated as high risk or one or more states that border one or more of the countries.

Example 85 includes the subject matter of any of Examples 67-84, and wherein to create one or more features comprises to create one or more features indicative of a presence of a predefined transaction pattern.

Example 86 includes the subject matter of any of Examples 67-85, and wherein to create one or more features indicative of a presence of a predefined transaction pattern comprises to create one or more features indicative of a presence of financial transactions that satisfy a size and frequency threshold.

Example 87 includes the subject matter of any of Examples 67-86, and wherein to create one or more features comprises to create one or more features indicative of a distance between a residence of an account holder and a zip code used most frequently by the account holder for financial transactions.

Example 88 includes the subject matter of any of Examples 67-87, and wherein to create one or more features comprises to create one or more features indicative of a number of times each account holder performed financial transactions at each of multiple locations.

Example 89 includes the subject matter of any of Examples 67-88, and wherein to create one or more features indicative of a number of times each account holder performed financial transactions at each of multiple locations comprises to create a feature indicative of the number of times each account holder performed financial transactions at one or more automated teller machines, branch offices, or cash vault locations.

Example 90 includes the subject matter of any of Examples 67-89, and wherein to create one or more features comprises to create one or more features indicative of network-related behaviors of the account holders.

Example 91 includes the subject matter of any of Examples 67-90, and wherein to create one or more features indicative of network-related behaviors of the account holders comprises to create one or more features indicative of a number of compute devices used by each account holder in a defined time period.

Example 92 includes the subject matter of any of Examples 67-91, and wherein to create one or more features indicative of network-related behaviors of the account holders comprises to create one or more features indicative of identities and number of account holders that share a compute device to conduct financial transactions.

Example 93 includes the subject matter of any of Examples 67-92, and wherein to create one or more features comprises to create one or more features indicative of comparisons of monthly financial transactions over 60, 90, or 180 day historical time periods.

Example 94 includes the subject matter of any of Examples 67-93, and wherein the instructions additionally cause the compute device to provide the historical financial transaction data to the money laundering scenario detection model.

Example 95 includes the subject matter of any of Examples 67-94, and wherein the instructions additionally cause the compute device to perform anomaly detection based on ranking Mahalanobis distances determined from the one or more features.

Example 96 includes the subject matter of any of Examples 67-95, and wherein to detect a commingling of funds scenario comprises to detect mixing of illicit funds with legitimate funds.

Example 97 includes the subject matter of any of Examples 67-96, and wherein to detect a conversion of bills from one denomination to a larger denomination comprises to detect the conversion based at least in part on a frequency of cash transactions, a ratio of deposits to withdrawals, or a proximity to one or more high risk countries.

Example 98 includes the subject matter of any of Examples 67-97, and wherein to provide an alert comprises to provide the alert to an analyst compute device.

Example 99 includes the subject matter of any of Examples 67-98, and wherein to provide an alert comprises to additionally provide the historical financial transaction data associated with the detected scenario.

1. A compute device comprising:
circuitry configured to:
obtain historical financial transaction data indicative of financial transactions made by account holders associated with a financial institution;
create, based on the historical financial transaction data, one or more features for use by a money laundering scenario detection model;
provide the one or more features to the money laundering scenario detection model to detect the presence of one or more cash-based money laundering scenarios, including at least one of commingling of funds or conversion of bills from one denomination to a larger denomination; and
provide, in response to a determination that a cash-based money laundering scenario has been detected, an alert indicative of the detected cash-based money laundering scenario.

2. The compute device of claim 1, wherein to create one or more features comprises to create one or more features indicative of a peer group comparison by industry and zip code.

3. The compute device of claim 2, wherein to create one or more features indicative of a peer group comparison comprises to create one or more features indicative of a comparison of cash-related financial transactions of each account holder to other account holders in the same zip code and industry.

4. The compute device of claim 1, wherein to create one or more features comprises to create one or more features indicative of an amount and frequency of cash-related financial transactions to or from countries designated as high risk or one or more states that border one or more of the countries.

5. The compute device of claim 1, wherein to create one or more features comprises to create one or more features indicative of a presence of a predefined transaction pattern by creating one or more features indicative of a presence of financial transactions that satisfy a size and frequency threshold.

6. The compute device of claim 1, wherein to create one or more features comprises to create one or more features indicative of a distance between a residence of an account holder and a zip code used most frequently by the account holder for financial transactions.

7. The compute device of claim 1, wherein to create one or more features comprises to create one or more features indicative of a number of times each account holder performed financial transactions at each of multiple locations.

8. The compute device of claim 7, wherein to create one or more features indicative of a number of times each account holder performed financial transactions at each of multiple locations comprises to create a feature indicative of the number of times each account holder performed financial transactions at one or more automated teller machines, branch offices, or cash vault locations.

9. The compute device of claim 1, wherein to create one or more features comprises to create one or more features indicative of one or more network-related behaviors of the account holders comprising a number of compute devices used by each account holder in a defined time period and/or identities and number of account holders that share a compute device to conduct financial transactions.

10. The compute device of claim 1, wherein the circuitry is further configured to provide the historical financial transaction data to the money laundering scenario detection model.

11. The compute device of claim 1, wherein the circuitry is further configured to perform anomaly detection based on ranking Mahalanobis distances determined from the one or more features.

12. The compute device of claim 1, wherein to detect a commingling of funds scenario comprises to detect mixing of illicit funds with legitimate funds.

13. The compute device of claim 1, wherein to detect a conversion of bills from one denomination to a larger denomination comprises to detect the conversion based at least in part on a frequency of cash transactions, a ratio of deposits to withdrawals, or a proximity to one or more high risk countries.

14. The compute device of claim 1, wherein to provide an alert comprises to additionally provide the historical financial transaction data associated with the detected scenario.

15. A method comprising:
obtaining, by a compute device, historical financial transaction data indicative of financial transactions made by account holders associated with a financial institution;
creating, by the compute device and based on the historical financial transaction data, one or more features for use by a money laundering scenario detection model;
providing, by the compute device, the one or more features to the money laundering scenario detection model to detect the presence of one or more cash-based money laundering scenarios, including at least one of commingling of funds or conversion of bills from one denomination to a larger denomination; and
providing, by the compute device and in response to a determination that a cash-based money laundering scenario has been detected, an alert indicative of the detected cash-based money laundering scenario.

16. The method of claim 15, wherein creating one or more features comprises creating one or more features indicative of a peer group comparison by industry and zip code by comparing cash-related financial transactions of each account holder to other account holders in the same zip code and industry.

17. The method of claim 15, wherein creating one or more features comprises one or more of: (i) creating one or more features indicative of an amount and frequency of cash-related financial transactions to or from countries designated as high risk or one or more states that border one or more of the countries; (ii) creating one or more features indicative of a presence of a predefined transaction pattern by creating one or more features indicative of a presence of financial transactions that satisfy a size and frequency threshold; (iii) creating one or more features indicative of a distance between a residence of an account holder and a zip code used most frequently by the account holder for financial transactions; and/or (iv) creating one or more features indicative of a number of times each account holder performed financial transactions at each of multiple locations.

18. The method of claim 17, wherein creating one or more features indicative of a number of times each account holder performed financial transactions at each of multiple locations comprises creating a feature indicative of the number of times each account holder performed financial transactions at one or more automated teller machines, branch offices, or cash vault locations.

19. The method of claim 15, wherein creating one or more features comprises creating one or more features indicative of one or more network-related behaviors of the account holders comprising a number of compute devices used by each account holder in a defined time period and/or identities and number of account holders that share a compute device to conduct financial transactions.

20. The method of claim 15, wherein detecting a conversion of bills from one denomination to a larger denomination comprises to detect the conversion based at least in part on a frequency of cash transactions, a ratio of deposits to withdrawals, or a proximity to one or more high risk countries.

21. The method of claim 15, wherein providing an alert comprises to additionally provide the historical financial transaction data associated with the detected scenario.
